(19) United States
(12) Patent Application Publication
(10) Pub. No.: US 2006/0152504 A1
(43) Pub. Date: Jul. 13, 2006

(54) Sequential retrieval, sampling, and modulated rendering of database or data net information using data stream from audio-visual media

(76) Inventor: James Alexander Levy, San Diego, CA (US)

Correspondence Address: GEORGE S. LEVY, 3980 DEL MAR MEADOWS, SAN DIEGO, CA, 92130, US

(21) Appl. No.: 11/324,550

(22) Filed: Jan. 3, 2006

Related U.S. Application Data
(60) Provisional application No. 60/643,132, filed on Jan. 11, 2005.

(51) Int. Cl. G06T 15/00

(52) U.S. Cl. 345/419

(57) ABSTRACT

A method of modifying through an interface operated by at least one user, as a function of an input data stream not interactively generated by said user, information originating from a search engine operating on a data source defined as a database or a data net. This method comprises the steps of: a) analyzing said input stream thereby generating search commands and rendering factors, b) searching said data source by applying said search commands to said search engine of said data source, c) retrieving data source search results generated by said search engine, d) rendering said search results according to said rendering factors thereby producing rendered search results, and e) sending said rendered search results to at least one video monitor thereby presenting said rendered search results to an audience.

### FIELD OF THE INVENTION BACKGROUND

This invention claims the benefit of U.S. Provisional Application No. 60/643,132 with the title, “Sequential Retrieval, Sampling, and Modulated Rendering of Database or Data Net Information Using Data Stream from Audio-Visual Media” filed on Jan. 11, 2005 and which is hereby incorporated by reference. Applicant claims priority pursuant to 35 U.S.C. Par 119(e)(i). The present invention relates to image rendering and display technology, more precisely to the automatic rendering and display of database and Internet information, as a function of an input data stream such as text or music.

### BACKGROUND

This invention aims at combining the flexibility of data sources such as databases or data nets (such as the Internet) with audio-visual media driven rendering techniques to form a new communication tool, mode of expression and art form. The data source may be designed specifically for the purpose of this invention or may be non-dedicated and contain visual, audio or textual information (such as photography or video data).

This invention brings together several fields of computer science and art. The first field of relevance to this invention is information visualization and more particularly web data visualization. Typically a user interacts with a database or a data net such as the web, by means of software such as a browser and/or a search engine running under an operating system. The result of the interaction is an image or a set of images displayed to the user's monitor. The rendering of the image is interactively controlled by software employed by the user. This software usually maximizes the clarity of the presentation without attempting to insert any artistic value to the displayed image and the web data visualization is usually interactive.

It is possible for the retrival of the web data to be mostly controlled by a non-interactive process such as a recorded, broadcast, or live data stream, which may, for example, include music. Some work has been done in this area such as the program called “Imagination Environment” written by David Ayman Shamma and Kristian J. Hammond at Northwestern University. Essentially keywords obtained from a closed captioned video stream are used to query a search engine programmed to obtain images from the web. The images are then displayed using a multiplicity of video monitors to the audience. No rendering of the images is performed.

A second field which has relevance to this invention is the rendering of images as is used in computer and video games and in computer (generated movies. It is typically an interactive process in which an artist interacts with a displayed image to achieve a certain artistic effect. For example, the artist may specify a set of rendering criteria such as the position of the sun or a light source, or the texture of a surface to achieve a particular rendering. The rendering can be done in real time by means of a dedicated video card, as in video games, or not in real time as in the making of animated movies.

A third field which has relevance to this invention is music visualization such as Winamp, Audion, and SoundJam. Some of the most popular music visualization programs include Geiss by Ryan Geiss, G-Force by Andy O'Meara, and Advanced Visualization Studio by Nullsoft. The real distinction between music visualization programs such as Geiss' MilkDrop and other forms of music visualization such as music videos or a laser lighting display is the visualization programs' ability to create different visualizations for each song every time the program is run. Thus the viewer receives a unique experience every time. In music visualization, the data that enters the visualizer program is a digital representation of the music itself with minimal interactive input from the user.

Prior art which is possibly relevant to this invention includes the U.S. Pat. No. 5,873,107 by Borovoy et al. This patent describes a system for automatically retrieving information relevant to text being authored. This is a method in which text entry and information retrieval are combined in such a way as to automatically offer an author continuous retrieval of information potentially relevant to the text he is authoring. The author enters text in one portion of the user interface. Keywords are extracted from the text as the author enters them and are used as query words for an information retrieval mechanism to a document collection. Those queries return relevant information from the document collection in a second portion of the user interface. The user can then read or ignore the returned information or he can select the returned information to view the full context from which it came. The invention by Borovoy et al. is interactive and does not make use of rendering of the retrieved information since this information is text.

Another invention, U.S. Pat. No. 5,523,945, by Satoh et al. provides a method for presenting related information in a document processing system. According to this method, the relationships between words included in an input character string are analyzed. At least one related element conforming to the analyzed relationships is extracted from the input character string. Subject sentences are retrieved from stored documents using the related elements as retrieval keys, and the retrieved subject sentences are displayed on screen. Priority rank is given to the respective subject sentences in accordance with the degrees of coincidence between the respective subject sentences and the related elements. The subject sentences are displayed on screen according to the given priority rank. As in the patent by Borovoy and al., this invention generates text information which is not rendered.

Yet another U.S. Pat. No. 5,649,186 by Ferguson describes a system and method for performing database operations on a continuous stream of tuples. Essentially it is a system and computer-based method that provides a dynamic information clipping service. An end-user creates a template of topics of interest via a graphical user interface and the template is transmitted to a central site for processing. At the central site, information relating to a particular base of knowledge is collected, parsed and indexed. The parsed and indexed information is stored in an information repository. The template is processed by parsing and collecting command-strings relating to the topics of interest found within the parsed template. The information repository is searched using the collected command-strings to generate query results, which are then sorted. A Hypertext Mark-up Language (HTML) page is created using the sorted query results. The page is then made available to the end-user for viewing, wherein the page represents a custom network-based newspaper. Ferguson's approach is interactive and the output result is not rendered.

Further features, aspects, and advantages of the present invention over the prior art will be more fully understood when considered with respect to the following detailed description claims and accompanying drawings.

### SUMMARY OF THE INVENTION

This invention describes a method or system of rendering imagery information originating from a search engine operating on a data source such as a database, a data net or the Internet. The imagery information is rendered as a function of an input data stream which may contain audio, video or text information and which is not interactively (generated by the user of the system. The operation of the system is controlled by the user through an interface. This method comprises the following steps:
a) analyzing and filtering of the input stream thereby generating search commands and rendering factors;
b) searching the data source by applying the search commands to the search engine of the data source;
c) retrieving search results generated by said search engine and which contain imagery information:
d) rendering the search results according to the rendering factors to produce rendered search results, and
e) sending the rendered search results to at least one video monitor to present the rendered search results to an audience.

Optionally this rendering method also comprises entering through the interface a set of parameters to be used in analyzing and filtering the input stream and using these parameters for controlling the analyzing and the filtering of the input data stream. This rendering method may also comprise entering through the interface search parameters to be used in editing the search commands before the search commands is sent to the search engine. The editing of the search commands could also be a function of information fed back into the editing process from the search results.

Optionally this rendering method also comprises entering through the interface editing criteria to be used in editing the search results, before the search results are send to a video monitor for display. It may also comprise entering rendering specifications through the interface to be used in editing or modulating the rendering factors before these factors are used in the rendering of the imagery. Means for selecting the source of the input data stream, and the source of the data source can also be provided.

The rendering of the imagery contained in the search result may comprises (geometrical transformations, chromatic transformations, morphological transformations, animation, operations drawn from the discrete integral or differential calculus, convolutions with images or functions, algorithmic operations on pixels of the imagery data. When several images are available, algorithmic operations used to define the pixels of one image may use data from the pixel of one or several other images. This rendering method may also produce single images or a video stream.

Optionally the input data stream or the data source may contains rendering factors or information such as annotations or closed captions used in defining the search commands or in editing or modulating of the rendering factors.

### BRIEF DESCRIPTION OF THE DRAWINGS

FIG. 1 presents a global and simplified view of the invention in functional form.

FIG. 2 provides a detailed view of the component processes that comprise the invention, including analyzing and filtering of the input media data to produce a search commands stream, database or data net operation, rendering the search results, and displaying the rendered information.

FIG. 3 provides a detailed view of the component processes that comprise the invention, including data entry through the graphical user interface, analyzing and filtering of the input media data, search command generation, database or data net operation, editing of the database or data net output, rendering the search results, and displaying the rendered information.

### DETAILED DESCRIPTION

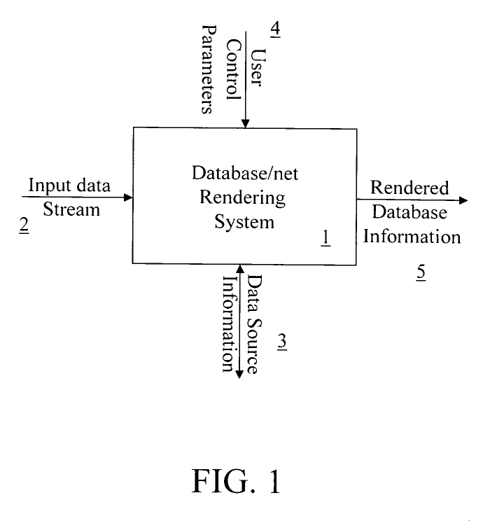

FIG. 1 provides a global view of the method described by this invention. It comprises a continuous rendering system 1 for database or data net information in which the rendering process is modulated by a continuous data stream from a media outlet, and in which the parameters of the rendering process are under the control of the operator. The term “operator” here refers to the person who is in control of the processes including the rendering process that leads to the display or presentation of the rendered video and audio information. The operator is not necessarily the same person as the target audience. For example he could be a DJ and the audience could be the party goers. The operator could also be the attendant at a web site dedicated to generate the imagery and associated rendering information for distribution through the Internet.

The invention requires the existence of a real-time continuous data input from a media outlet 2 such as a musical data stream, a voice input, or continuous text input. For the sake of simplicity, this continuous media input shall be called the input data stream.

This invention also requires access to a searchable data source 3 in the form of an audio-visual database or a searchable audio-visual data network. This database or data net 3 could be dedicated for the purpose of this invention, in other words, the information that it contains may be selected by, or otherwise under the control of, the operator. Information in such a dedicated database could conceivably either be sold as a commercial product or be made publicly available. The database or data net (such as the Internet) may also be non-dedicated. For the sake of simplicity, this database, or data network shall henceforth be referred to as “data source.” The type of information in this data source includes but is not limited to text, audio and video data.

Furthermore, the invention may also require an operator to enter controlling parameters 4 through a graphical user interface. These controlling parameters 4 modulate the operation of the system 1, including the selection of the source for the input data stream 2, the modulation of the analysis and filtering of the input data stream 2, the (generation of rendering factors from the input data stream 2, the generation of the search commands sent to the data source (database or data net), the editing of the search commands, the editing of the data source search results, and the modulation of the rendering of the search results according to rendering specifications entered by the operator.

The output of the system 5 consists of a continuous stream of rendered audio-visual information. This output called the rendered search results are sent to a displaying or presentation device.

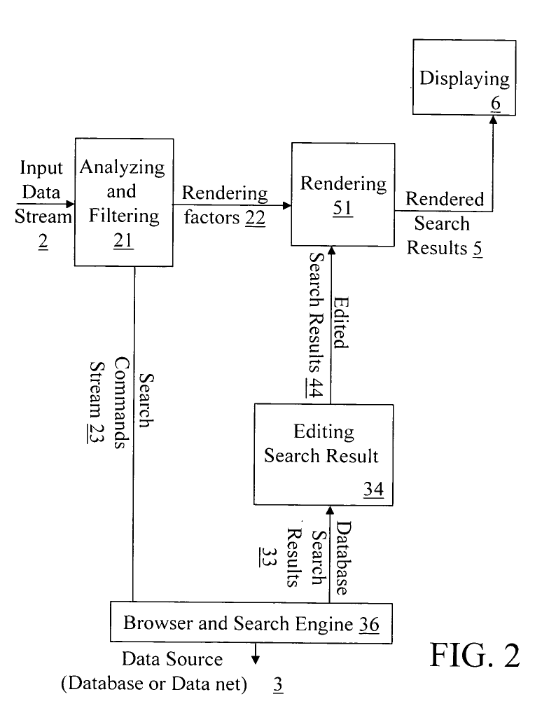

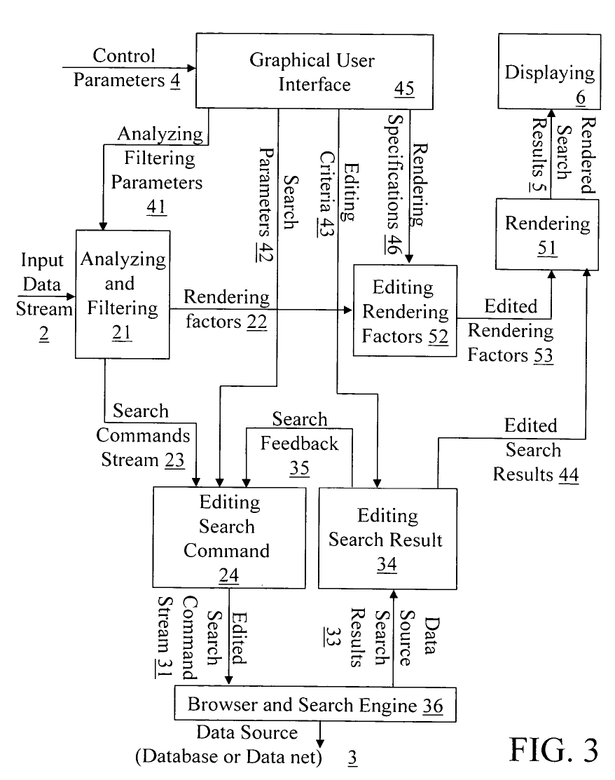

Essentially, as described in more detail in FIG. 2 and FIG. 3 the invention comprises the following steps:
1) Selecting the source of the input data stream 2
2) Entering analysis and filtering parameters 41 for controlling the input data stream.
3) Analyzing and filtering of the input data stream according to the analysis and filtering parameters 41 to produce rendering factors and search commands 23.
4) Selecting the data source (database or data net) by entering some search parameters 42 or by making a physical connection.
5) Entering additional data source search parameters 42 if necessary.
6) Generating editing search commands 31 from search commands 23 according to search parameters 42 if needed.
7) Applying search commands 23 to search engine 36 of data source and retrieving search results 33
8) Entering data source search editing parameters 43.
9) Editing/sampling the data source search results 33 to produce edited search results 44 if needed.
10) Entering rendering specifications 46 if needed.
11) Editing the rendering factors 52 to produce edited rendering factors 53.
12) Generating rendered search result 5.
13) Presenting rendered search results 5 to an audience.

Each of the above points will be discussed in turn.

Selecting the Source of the Input Data Stream.

The selection of the source of the input data stream 2 can be made in different ways to achieve different degrees of flexibility. For example the input data stream could be defined when the hardware is manufactured, when the software is configured or just before the software is run. The input data stream selection can be made by the manufacturer, by the installer, by the operator or by the user or audience. The input data stream can originate from a radio station, satellite station, TV channel, Cable channel, Satellite channel, or an Internet site dedicated to the task. Alternatively the input data stream can originate from a local playback system such as a turntable, a CD player or a DVD player or from a live performance in digital or analog form. The selection of the input data stream can be made by a graphical user interface 45 or can be fixed at manufacturing time.

Entering Analysis and Filtering Parameters 41 for Controlling the Input Data Stream.

In addition to selecting its source, the operator may want to alter or modulate the input data stream 2 by an analysis and filtering process 21. He can do this by entering, analyzing and filtering parameters 41. The input stream 2 can be of different types. These types includes the following:
1) Text or lyrics
2) Annotated text or lyrics. (The term “annotated” means that the data is annotated or supplemented to specify additional information beside the pure text or lyrics. This information may include but is not limited to font and formatting as in rich text, time stamps, rendering information and data source search information)
3) Annotated Digital Music. Here again the term annotated implies at least all the possibilities outlined above.
4) Annotated Video (such as closed caption)
5) Non-Annotated Digital or Analog Voice or video including a sound track.
6) Non-Annotated Digital or Analog Music

Text or Lyrics: The analysis of the input data stream 2 comprised of text or lyrics is possibly the simplest case from the point of view of the input data. The input stream 2 consists of text which can be used directly to generate keywords and rendering factors. This can be done for example as follows: the input stream is parsed using spaces as delimiters. The retrieved text words are then matched against an analysis and filtering lexicon. If a word from the lyrics matches a word from the lexicon, this word becomes a keyword and it is incorporated in the output search commands stream 23. Simultaneously, rendering factors 22 corresponding to this keyword can be generated as follows: a set of rendering factors 22 could be stored in association with each lexicon word, and/or could be part of the parameters 41 for controlling the input stream 2. The rendering factors could be used as parameters for an algorithmic rendering process or could simply be fixed rendering instructions. Thus when a keyword is generated, rendering factors 22 appropriate for that keyword are retrieved and sent to the rendering module 51. The lexicon may be part of the analysis and filtering program or may be entered or edited by the operator as part of the parameters for controlling the input stream.

Annotated Text or Annotated Lyrics: In this case, the input data stream 2 contains information other than simple text. It may comprise some or all of the parameters used by the analyzing and filtering module 21. It may also comprise parts of the search commands stream 23 such as keywords, links or possibly the entire command stream 23. It may also include time stamps, mood tags, topical tags, or other information required by the rendering process. Mood tags include codes for emotions such as “happy”, “sad,” “angry,” “subdued,” “hopeful,” “in love,” etc. Topical tags include codes for objective content such as “child,” “bird,” “guitar,” “race car,” “flag,” etc. More generally this information may include codes that help direct the analyzing process 21, the rendering process 51 or the data source search engine 36.

Annotated Digital Music: In this case the input data stream 2 comprises music in digital form and may also include time tagged and/or pre-programmed digital annotations such as closed caption. As explained in the above paragraph these annotations can be expressed in a format chosen to facilitate the operation of the analyzing and filtering module 21, the search of the data source 3 and the rendering module 51. In addition, the annotations may include explicit sound information such as frequency, amplitude or rhythm, or even MIDI tags, synchronously with the music.

Annotated Video. Closed caption are text information formatted into the video signal. This text information can be used as outlined above.

Non-Annotated Digital or of Analog Voice or video including a sound track. When the input stream 2 contains a voice, a simple alternative is to use spectrum analysis software or the like to produce frequencies and/or amplitudes and/or beat (rhythm) information to generate rendering parameter 22 information. It may also be possible, using frequency amplitude and beat to generate data source search commands 23. Admittedly, diversity in the search commands 23 would be reduced, but the resulting search result 33 and rendering search result 5 may still be of artistic interest, especially when the data source is dedicated to the task. Some flexibility could be achieved by using a look up table or an algorithm to convert the output of the Analysis and Filtering Module to generate source search commands 23 or rendering information 22.

A more complex approach requires the use of a voice recognition system to generate data source (database or data net) search commands 23 (such as keywords) and rendering factors 22 from the voice signal.

Non-Annotated Digital or of Analog Music: Since music, in general, does not have clear unambiguous meaning and convey moods rather than hard facts, musical characteristics of the input stream 2 such as the frequency, amplitude and rhythm obtained by the appropriate analog to digital conversion technology, can be applied to appropriate look-up tables or algorithms to generate search commands 23 and rendering factors 22. These algorithms or look-up tables may be entered and modified by the operator.

Analyzing and Filtering of Input Data Stream.

The operator enters analyzing and filtering parameters 41 which are fed into, and modulate the operation of the analyzing and filtering module 21. This process receives the input data stream which may include voice, music accompanied with annotation such as lyrics, mood tags, topical tags, times stamps, frequency, amplitude, beat, as well as rendering or data source searching instructions. The module extracts this information from the input data stream and performs, if necessary, a spectral analysis of the music to generate frequency, amplitude and beat information. This process generates in real-time the following:
1) A stream of data source (database or data net) search commands 23 which may include, for example, keywords, and
2) A stream of modifying, modulating or rendering factors 22

Thus the output of the analysis and filtering 21 includes search commands stream 23 and a rendering factor stream 22.

Selecting the Data Source (Database or Data Net).

As with the input data stream, the data source which may be a database or a data net 3 can also be selected in different ways to achieve different degrees of flexibility. For example the data source 3 could be defined when the hardware is manufactured, or when the software is installed or at run time by the user. In the case of a database, it could take the form of a file installed on a CD, a DVD, a hard drive or any other type of mass data storage. In the case of a data net, it could take the form of a local area network or a wide area network. The whole network could be searched or a subset of it, as defined for example by a single link or several links. The operator may be given the option to select and/or modify the source of the database or data net.

Entering of Additional Data Source Search Parameters 42.

The operator may have the option through the use of a graphical user interface 45 of entering and monitor search parameters 42 to be applied to the data source (database, data net or Internet) search engine 36. The operator may want to remain within a particular theme, and therefore may want to modify the search parameters 42 by such means as a keyword conversion table. He may also include in the search parameters 42 additional terms having the purpose of directing the search of the data source and/or restricting the scope of the search.

Generating Editing Search Commands

The data source search parameters 42 that have been entered by the operator are utilized by the search command editing 24 module to modify or filter the data source search commands 23 and to generate the edited search command stream 31. Depending on the capability of the data source search engine 36, different methods may be employed to perform this modification or filtering. For example, some database search engines, such as the one at the United State Patent and Trademark Office have a full AND, OR and NOT capability including the use of wild cards. Search methods used by other search engines may be trade secrets and may not have such clear cut ability. For example Google assigns weights to sites according to the number of links pointing to them. In addition, in Google the logical operator AND is implicitly inserted between keywords. Often the exact algorithm of publicly accessible search engines is proprietary and not made public. Thus the method of modifying and composing the search command stream 23 or adding to it operator-entered search parameters 42 must approximately conform to and utilize the function of the particular data source in use. Other search engines may rely on natural language-like commands in which case the search command would have to be phrased accordingly.

It is important to note that control parameters 4 may be edited by the operator who could be a disk jockey (DJ) or a video jockey (VJ). This feature akin to “turn table scratching” could add dynamics to the continuous display 6, and would allow the operator to respond to the mood of the participants or create a desired effect in a live or party environment.

Applying Search Commands 23 to Search Engine 36 and Retrieving Search Results 33 from Data Source 3.

The edited search command stream 31 is sent to the data source search engine 36 as a continuous sequence of searches commands. In response, the data source search engine 36 returns the data source search results 33. This operation is well known to those versed in the art of database, data net and Internet design. Similar functions are performed by search engines such as Google and Yahoo. Upon completion of the search, search results 33 are retrieved.

Entering Data Source Search Editing Parameters 43.

When the data source (database or data net) is large, the results of a search may become unpredictable and undesirable. Furthermore, when the search engine 36 is outside the control of the operator, for example in cases where the operator is searching on the internet, his search may generate offensive material. Another layer of filtering controlled by the editing parameters 43 can give the operator the option of eliminating such material from the output of the search.

Editing of the Data Source Search Results.

The output of the search may be a sequence of data fields from the data source (database or data net.) It could also be a sequence of links to data net sites or to the Internet. This data must be purged of all undesirable material according to the parameters specified by the operator. The editing parameters 43 entered by the operator can be used to edit the result of the search by the search result editing process 34. Such filters, such as parental filters, are well known to people well versed in the art. Basically these filters scan the sites being tested and search for offensive words or tags. Sometime the filters compare the addresses of these sites to addresses in a look-up table containing black-listed sites.

Optionally, a search feedback 35 data path could be established in the data source search such that the generation of search commands could be modified by information drawn from the data source in a previous search. For example, an Internet site that has just been accessed could include a link to another site which may contain interesting imagery that could be displayed. Thus source data could comprise information in the form of links which is fed back to the search process in subsequent searches. This feedback could be completely unaltered or could be modulated by the command information 23 coming from the input data stream 2 or by the editing criteria 43 from the graphical user interface 45.

Optionally again, it may be possible to achieve a different kind of feedback when data has been gathered from the audience, to achieve a more personalized selection of the imagery and rendering of the images. Profile gathering software, or preference gathering engine exist that generate Such user profile as for example those software that produce cookies. These programs could generate their information from a compilation of user's selection of input data stream 2, control parameters 4, and rendering modes, and his preference regarding shopping, browsing, listening, and viewing or any other user behavior with respect the database or data net. Such data gathering on users may keep the user name anonymous or does not have to be user specific, and may be used to enhance the data source search operation and the rendering function.

Editing the Rendering Factors 52 to Produce Edited Rendering Factors 53.

The rendering operation could be under the control of the operator. He could enter rendering specifications 46 to edit or modulate the rendering factors 22.

Generating Rendered Search Result 44.

The rendering factors 22 can now be applied through the rendering process 51 to the edited search results 44. When the search results are images, there is a multitude of rendering operations that can be utilized. These include but are not limited to zooming, negative inversion, partial or gradual transparency, fading, cropping, scaling according to arbitrary axes, rotation, flipping, swirling, shattering, shadowing, pixelizating, blurring, pulsating, strobing, coloring, graying, merging, morphing, contouring, cross-fading and cross-zooming. Image rendering software on the market such as RahmanImager offers more than 140 filters, effects, deformations and distortions tools and artistic colorizing. To mention a few, they include gamma correction, contrast, emboss, engrave, noise, greyscale, relief, erode, dilate, painting, edge enhance, contour, soften, sharpen, blur, saturation, brightness, invert, halftone, pixelize, thermique, X-black, photocop, lens, wave, bend, fold, tile, twirl, scanlines, grid, flare, glass, curtain medium tones, stretch histogram, simple blur, smart blur, heavy blur, softener blur, motion blur, far blur, radial blur, zoom blur, gray tones, sepia effect, ambient light, tone adjustment, mosaic, diffuse, rock effect, noise, melt, fish eye, customized fish eye, twirl, twirl extension, swirl, make 3D, four corners, caricature, roll 360, polar coordinates, cylindrical, simple wave, block wave, circular wave, circular enhanced wave, backdrop removal, neon, detect borders, find edges, note paper, adjust inversion, monochrome, random points, solarize, canvas adjustment, relief, tile effects, fragment, fog effect, oil paint, frost glass, rain drop, RGB tweaking, old photo, sketch, isolate, sepiatone, hue stretch & rotation, grey rotation, equalize, rotation, replace, swap and much more.

More generally the term rendering in this invention includes any algorithmic operations applied to the pixels of a single (still or video) image or those applied to the pixels of multiple (still or video) images. Single image rendering comprises but is not limited to geometrical transformation, chromatic transformation, morphological transformation, discrete differentiation also called difference, discrete integration also called summation, convolution with images or functions, application of non-linear functions, and animation. Multiple image rendering comprises algorithmic operations according to which the pixels of at least one of said image affect the pixels of at least one other image. These operations include but are not limited to morphing, cross-fading, cross-zooming and cut and paste substitution.

Morphing represents a special case because, traditionally, it requires a human to assign corresponding dots to the initial image and to the final image, to guide the morphing process. In this invention, because the rendering process is not manual, at least two alternative methods can be used to perform this automatically. The first method assumes that the dot information is received through the input data stream or is found tagged to the image in the data source 3. This approach is possible with dedicated databases or data nets. The second method relies on a software pattern recognition process according to which corresponding dots in the images are generated by software. Research in this area has been done by Karl Walter in his PhD Thesis entitled Real-Time view morphing of video streams written for the Department of Computer Science at the University of Illinois at Chicago in 2003.

Algorithms for performing these rendering functions are well known to those people versed in the art. The rendering factors 22 must be designed to conform to the algorithms input requirements. The output of the rendering process consists of the rendered search results 5 which can be sent to a display 6 for viewing.

Because the input stream may in itself be open to manipulation by the operator such as a DJ or VJ, then any operation of the input stream by the operator such as, for example, the selection of a new input stream in a graduated manner also called “cross-fading” may automatically affect rendering 51. When the input stream originates from a mechanically driven device such as a turntable or a CD drive, any manual alteration of the operation of the drive such as “scratching” could also affect the rendering process 51.

Since the operation of the invention is simplest when the digital input data stream 2 includes annotations describing, defining or supplementing the search commands stream 23, and/or describing, defining or supplementing the rendering factors 22, it may be desirable for the operator to edit the input stream 2 before its use, and add annotation according to his wishes. The operator could begin either by recording a live input data stream or from an already recorded input data stream 2. He could then use his graphical operator interface 45 to include annotations appropriately formatted to ensure the synchronicity between the input stream and the annotations. This formatting can be done in several ways. For example the input data stream 2 data packets and the annotations could be recorded in the same file with each data packet supplemented by annotation to ensure the synchronicity between the data stream 2 and the annotations. Alternatively, the input data stream 2 and the annotations could be recorded in different files with time stamps assigned to each to insure their synchronicity.

The data source 3 (database or data net) could be publicly accessible or private. As mentioned before, a public data source could be the Internet. Because such a data source is not under the control of the operator and to avoid unpredictability and possibly offensive results, a significant effort must be spent in the filtering 24 of the search commands 23 and in the editing 34 of the search results 33. This problem can be greatly alleviated by using a private data source 3 a-priori prepared and ““themed” for the intended type of input stream. For example, in the case when the audience is at a bar-mitzvah or wedding, the database may comprise family photographs. The data source 3 could also be encrypted to be meaningful only for a correspondingly encrypted input data stream 2. For example the annotation code in the input data stream 2, used to generate the search commands stream 23, could be selected to match encrypted keywords used to search the data source 3. This feature could function as an anti-piracy mechanism.

The rendered search results could be a video stream. This may happen in several ways. 1) The search results are themselves a video stream in which each image is rendered separately. 2) The search results are a single image but the rendering varies with time to provide a dynamic rendering of the image. 3) The search results is a video and the rendering varies in time according to predetermined rendering factors and/or according to the sequence of images generated by the search results.

Presenting Rendered Search Results.

Finally the rendered search results 5 can be displayed to an audience. This can be done live or by means of recording for later presentation. Some of the basic ideas of this invention can be illustrated by means of the two following examples:

### EXAMPLE 1

This example includes an input data stream 2 consisting of audio media accompanied by lyrics. The lyrics are time stamped as in a Karaoke file. An XML or SGML markup language can be used to add the time stamps to the original lyrics. No additional annotation for the purpose of data source searching, sampling and rendering are encoded in the input data stream. The data source 3 in use is the Internet. For explanatory purposes this example shall assume a specific state of the input data stream 2 and of the data source (i.e. Internet) 3. We shall assume that the input data stream 2 carries the Beatles song “All You Need is Love.”

The process begins as the analyzing and filtering module 21 receives the input data stream 2 which contains the lyrics (or textual portion). This module begins by parsing the lyrics using spaces as delimiters. The parsing process operates on each verse or line of the lyrics at a time. Thus for each input verse, it generates strings of characters (words) which are then utilized to control the searching of the Internet and the rendering of the search results. The song lasts a few minutes but for the sake of simplicity let's consider the verse “All you need is love.” The parsing process generates the strings “All,” you,” “need,” “is,” and “love.”

These words are then evaluated by the analyzing and filtering module 21 for their suitability in controlling the searching of the data source (Internet) 3 and the rendering 51 of the results. This can be done in a variety of ways: for example, each word could be looked up in an internal suitability lexicon to assign to each word a searching suitability index, and a set of rendering factors. The words are then ranked or selected according to their suitability index. As a result of this analysis the words “All,” “you” and “is” are eliminated because of their lack of specificity as expressed by their low suitability indices and/or their complete absence in the suitability lexicon. The words “need” and “love” are found to have a suitability index exceeding a suitability threshold specified by the operator in the analyzing and filtering parameters 41. In addition, also as specified by the operator, a maximum of two strings can be retained by the analyzing and filtering software. Therefore, the words “need” and “love” are retained. (Had there been more than two suitable words, the two words with the highest suitability index would have been retained.)

These two words are sent as part of the search commands stream 23 to the search command generating module 24. In addition, rendering factors 22 associated to these two words are sent to the rendering module 51.

The search command editing module 24 generates the edited search command stream 31 by utilizing the search commands stream 23 originating from the data input stream 2 and the search parameters 42 entered by the operator. In this particular example, the operator is aware of the particular input data stream 2 “All you need is love” and has temporarily configured the search command editing module 24 by entering search parameters 42 designed to narrow down the search. In particular he has eliminated the tennis related homonym “love” (meaning zero score) including in the search entry the operator specified term, “NOT(tennis).” In addition, the operator has specified the expression “Photo OR Photograph OR Image OR Painting” to increase the likelihood of getting images or artwork. Furthermore, the operator has specified a maximum number of returns from the search engine 36 to be equal to ten or less. Two search queries are assembled by the search command editing module 24. The first is “need AND NOT(tennis) AND (photo OR photograph OR image OR painting)” with a maximum number of returns equal to ten. On Google this search query could be expressed as “need-tennis (photo OR photograph OR image).” The second query is “love AND NOT(tennis) AND (photo OR photograph OR image OR painting)” with a maximum number of returns equal to ten. On Google this search query could be expressed as “love-tennis (photo OR photograph OR image).” As is well known the search process can be facilitated by the use of tags such as XML tags that describe the content of web material. In response to these two queries, the data source search engine returns two sets of search results 33, each including ten sites containing images. This information is sent to the module for editing search results 34.

The editing search results filtering module 34 then narrows down the list search result list 33 by applying the operator-specified editing criteria 43 and whenever possible, using XML tags associated with images found at each site. In this particular example, because of the use of the word “love,” there is a possibility that pornographic material has been retrieved. We shall assume that the operator may want to eliminate this material and that he has configured the editing search result filtering 34 by entering a set of editing criteria 43. Any site containing sexually explicit offensive wording listed in a black-list lexicon or words related to business transactions is eliminated.

After the application of these criteria, the list is reduced to two entries for the “need” query and to three entries for the “love” query. Since there is still a need for further list reduction, the editing search result module 34 performs the final selection or “sampling” by means of a pseudorandom mechanism. This process finally reduces each list to a single entry which happens to be (as possibly described by their XML tags) for the “need” query, a site containing the famous painting by Edvard Munch entitled “The Scream.” For the “love” query, the retained entry is a link to photograph entitled “man-woman-kissing.jpg”. Both images happen to be JPEG encoded. The editing search result module 34 extracts for each Internet site the relevant images displayed there. It then sends these images to the rendering module 51 together with their image encoding formats and if available, the corresponding XML tags.

The rendering module 51 receives rendering specifications 46 from the operator, which it uses to configure its rendering operations. It also receives from the analyzing and filtering module 21 a set of rendering factors 22 specific to the particular input stream being received. Finally it received the images to be rendered from the search results editing module 34.

The rendering module 51 begins with the “The Scream” image. The module first checks if the XML data has any recommended rendering information. If there is rendering information encapsulated in the XML code, then the rendering process executes that information. Otherwise it falls back to a default rendering process. As it happens in this example, there is no XML tag (or the tag has no recommended rendering). The fallback program is then executed. The JPEG image is decompressed into a bit map format and scaled and cropped according to the size specified by the rendering specifications 46 entered by the operator. The image is now the same size and format as the previous image that has been displayed. The rendering module is now ready to make use of the rendering factors 22 generated by the analyzing and filtering module 21.

The rendering factors 22 for “need” include the following: 1) musically derived data such as frequency, amplitude and rhythm timing, 2) a set of operators defining geometric, chromatic and morphological transformations to be applied to the image and how these transformation are to be modulated by the musically derived data. In this example the operators include a transitional operator consisting of a cross-fade with the previous image (gradual reduction of brightness of previous image accompanied by gradual increase of brightness of new image). Following this cross-fade, the next operator is a fishbowl effect to be applied in steps, where the step sizes are proportional to the musical amplitude and the steps intervals correspond follow the rhythm. Superimposed on this, the chromaticity of the image is made to shift toward the red and become darker. As mentioned before, these transformations correspond to the word “need” and are applied immediately at the beginning of the verse “All you need is love.” Since the rendering is specifically associated with the word “need” these rendering transformations end immediately after the word “need” is sounded. The word “love” initiates then a new rendering process.

The rendering software 51 then retrieves the image “Man-Woman-Kissing” that has been generated by the editing search result module 34. The module then checks if the XML data has any recommended rendering information. As it happens in this example, there is no XML tag (or the tag has no recommended rendering) for this image. The fallback program is then executed. The JPEG image is decompressed into a bit map format and scaled and cropped according to the size specified by the rendering specifications 46 entered by the operator. The image is now the same size and format as the previous image (“The Scream”) that has been displayed. The rendering module 51 is now ready to make use of the rendering factors 22 generated by the analyzing and filtering module 21.

The rendering factors 22 for “love” include the following: 1) musically derived data such as frequency, amplitude and rhythm timing, 2) a set of operators defining geometric, chromatic and morphological transformations to be applied to the image and how these transformations are to be modulated by the musically derived data. In this example the operators include a transitional operator. This operator consists of the fragmentation and explosion with zoom out of the previous image “The Scream,” followed by its replacement by the new image, Man-Woman-Kissing. The image is then dilated in steps with the step sizes being a function of the musical amplitude and the step intervals being synchronized with the rhythm. Superimposed on the dilation, the chromaticity of the image is changed towards the blue and the brightness is made lighter.

### EXAMPLE 2

In this example, we shall assume that the input data stream 2 includes lyrics that have been annotated by means of XML or SGML tags. These annotations carry not only time stamps, as in Example 1 but also instructions for performing database or data net searches and rendering of images. In addition, the data source 3, unlike Example 1, is a database and under the control of the operator (or the vendor or the manufacturer.) This database can be in a CD (the content of which could be downloaded into a hard drive before its use to speed up the search) or made available by a server attending a specific site on the Internet. Since all inputs to the system are fixed, the output including the rendering of the images is completely reproducible and therefore can be rehearsed by the operator before presentation to an audience.

In this example we shall use as input stream 2 the song “Hypnotize” from the rapper “Notorious BIG.” For the sake of simplicity we shall consider only the verse “Biggie biggie biggie can't you see.”

The analyzing and filtering module 21 receives the input stream in digital format, which contains the lyrics together with the annotations. The module parses each verse (or line) of the lyrics one at a time and retrieves the annotations. The retrieved information includes the words “Biggie” repeated three times, “can't,” “you” and “see.” The tags include instructions to the parser to select the first “Biggie” and “see,” and to ignore the other words.

Associated with each of these selected words are database search and image rendering information. Search commands 23 for the search engine 36 are sent to the search command editing module 24. The image rendering commands 22 are sent to the rendering module 51.

The search command editing module 24 utilizes the search commands stream 23 from the input data stream and operator-entered search parameters 42 to generate the edited search commands 31. In this particular example, the search commands stream 23 includes only two search commands and no other information is needed by the search command editing module 24. The first command which is associated with the word “Biggie” requests the retrieval from the data source 3 (i.e., database) of the image “Biggie.gif.” The second search command, associated with the word “see,” requests the retrieval of a close up image of an eye, “Iris.jpg.” The Search Result 33 information is sent to the editing search result module 34.

The task of the editing search result module 34 is to amend the search information according to the instructions located in the editing criteria 43 specified by the operator. As it happens, because of the dedicated nature of the input data stream 2 and of the source 3 (database), no editing criteria has been entered. Consequently, the editing module 34 passes on the information as editing search results 44 to the rendering module 51.

The rendering module 51 receives rendering specifications 46 from the operator-controlled graphical user interface, which it uses to configure its rendering operations. As it happens in this particular example, all rendering information originates from the input data stream 2 and is passed on to the rendering module 51 by the analyzing and filtering module 21. The rendering module 51 converts the images into bitmap format and scales them according to the XML or SGML instruction to make them ready for display.

The rendering information coded in XML or SGML format and associated with the word “Biggie” arrives first. This information includes 1) transitioning from the previous image by means of a fading-out followed by a fade-in of an amber and black checkerboard background. 2) Gradual application of a swirl operator to this background modulated by a strobe operator synchronized with the rhythm of the music as specified in the rendering factors. 3) A cross fading (slow reduction of the current image accompanied by slow increase of the new image) of the image “Biggie,” synchronized with the second recitation of the word “Biggie” in the song.

The rendering factors 22 corresponding to the next word “see” are then retrieved. They consist of the following: 1) a transitional operator called “cross-zooming” that consists of zooming out of the current image while zooming in the new image from an oversize scale. This transitional operator is applied between the currently displayed image “Biggie” and the bit map version of the new image “Iris.jpg.” 2) A chromaticity operator shifts the color of the image towards the green. 3) A diagonal red streak operator to apply red streaks to the image several times in synchrony with the rhythm of the music, each application having random vertical shifts.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

### REFERENCES

Real-Time view morphing of video streams by Karl Walter, PhD Thesis for the Department of Computer Science at the University of Illinois at Chicago, 2003
French Patent FR2727543 Procede de Generation d'Images Intermediaires par Interpolation, by S. Beucher, F. Meyer, J. Serra.

I claim:

1. A method of modifying through an interface operated by at least one user, as a function of an input data stream not interactively generated by said user, information originating from a search engine operating on a data source defined as a database or a data net or the Internet, said method comprising the steps of:
a) analyzing and filtering of said input stream thereby generating search commands and rendering factors;
b) searching said data source by applying said search commands to said search engine of said data source;
c) retrieving data source search results generated by said search engine;
d) rendering said search results according to said rendering factors thereby producing rendered search results, and
e) sending said rendered search results to at least one video monitor thereby presenting said rendered search results to an audience.

2. A method as of claim 1 also comprising the step of entering analysis and filtering parameters by said user through said interface and using said analysis and filtering parameters for controlling said analyzing and filtering of said input data stream.

3. A method as of claim 1 also comprised entering search parameters by said user through said interface, and editing said search commands using said search parameters, before said search commands are sent to said search engine.

4. A method as of claim 3 wherein said editing of search commands utilizes information comprised of data fed back from said search results.

5. A method as of claim 1 also comprised entering editing criteria by said user through said interface, and editing said search results using said editing criteria, before said search results are send to said video monitor.

6. A method as of claim 1 also comprised of entering rendering specifications by said user through said interface, and using said rendering specifications in editing or modulating said rendering factors before said rendering factors are used in said rendering.

7. A method as of claim 1 also comprised of selecting the source of said input data stream.

8. A method as of claim 1 also comprised of selecting the source of said data source.

9. A method as in claim 1 wherein said rendering of said search results comprises geometrical transformations.

10. A method as in claim 1 wherein said rendering of said search results comprises chromatic transformations.

11. A method as of claim 1 wherein said rendering of said search results comprises morphological transformations.

12. A method as of claim 1 wherein said rendering of said search results comprises animation.

13. A method as of claim 1 wherein said rendering of said search results comprises operations drawn from the discrete integral or differential calculus.

14. A method as of claim 1 wherein said rendering of said search results comprises convolutions with images or functions.

15. A method as of claim 1 wherein search results comprises imagery data comprising of at least one image and said rendering comprises algorithmic operations on pixels of said imagery data.

16. A method as of claim 1 wherein search results comprise several images and said rendering comprises algorithmic operations according to which the pixels of at least one of said images affect the pixels of at least one other of said images.

17. A method as of claim 1 wherein said rendered search results is a video stream.

18. A method as of claim 1 wherein said input data stream contains rendering factors.

19. A method as of claim 1 wherein said data source contains rendering information, said rendering information is used in editing or modulating rendering factors.

20. A method as of claim 1 wherein said input data stream comprises annotations or closed captions which are used in defining said search commands or said rendering factors or both.

21. A method for at least one user, of rendering through a user interface and as a function of an input data stream not interactively generated by said user, information originating from a search engine operating on a data source defined as a database or a data net, said method comprising the steps of:
a) entering analysis and filtering parameters through said interface and using them in analyzing and filtering input stream thereby generating search commands and rendering factors;
b) entering search parameters through said interface, and using said search parameters in editing search commands, thereby generating edited search commands:
c) entering said edited search command into said search engine, and retrieving search results from said search engine;
d) entering editing criteria trough said interface, and using said editing criteria in editing said search results, thereby generating edited search results;
e) entering rendering specifications through said interface and using said rendering specifications in editing or modulating rendering factors, thereby generating edited rendering factors;
f) using edited rendering factors in rendering edited search results thereby producing rendered search results, and
g) displaying rendered search results.

22. A system operated by at least one user for retrieving images from a search engine operating on a searchable data source defined as a database or a data net, and rendering those images according to rendering factors generated from an audio-visual input data stream not interactively generated by said user, said device comprising:
a) a graphical user interface by means of which said user can enter operational data comprising analyzing filtering parameters, search parameters, editing criteria and rendering specification;
b) an analyzing and filtering module that processes said input data stream according to said analyzing and filtering parameters, and generates search commands, and rendering factors;
c) a search engine operating on said searchable data source, that accepts said search commands and generates data source search results;
d) a rendering module that uses said rendering specifications and said rendering factors to operate on said search results and produce rendered search results, and,
e) a display that accepts and displays said rendered search results.

23. A system as in claim 22 also comprising an editing search command module that receives search parameters from said graphical user interface and search commands from said analyzing and filtering module, and edits said search commands according to said search parameters, before they are sent to said search engine.

24. A system as in claim 22 also comprising an editing search result module that receives search results from said search engine, and editing criteria from said graphical user interface and edits search results before they are sent to said rendering module.

25. A system as in claim 22 also comprising an editing rendering factor module in which rendering factors are edited or modulated according to rendering specifications that it receives from said interface, before said rendering factors are sent to said rendering module.
